(19) United States
(12) Patent Application Publication
(10) Pub. No.: US 2009/0255801 A1
(43) Pub. Date: Oct. 15, 2009

(54) Programmable Electrode Arrays and Methods for Manipulating and Sensing Cells and Substances Using Same

(76) Inventor: Alfred M. Haas, Hyattsville, MD (US)

Correspondence Address: Alfred M. Haas, Apt. 31, 3410 Tulane Drive,, Hyattsville, MD, 20783, US

(21) Appl. No.: 12/422,271

(22) Filed: Apr. 11, 2009

Related U.S. Application Data
(60) Provisional application No. 61/044,273, filed on Apr. 11, 2008.

(51) Int. Cl. G01N 27/26

(52) U.S. Cl. 204/164; 204/600

(57) ABSTRACT

This invention pertains to densely integrated programmable electrode arrays for sensing and manipulating biological cells and substances. Using the programmable electrode arrays according to a method of the invention, it is possible to generate arbitrary, dynamically reconfigurable electric field patterns on and around the electrodes at magnitudes which have been shown to induce neurite outgrowth and enhance cellular regeneration of damaged tissue. It is also possible to use the programmable electrode arrays to sense signals coupled to or in close proximity with the electrodes of the array, and to program arbitrary gain, calibration and offsets onto the individual electrodes of the array and/or their associated circuit elements.

### CROSS-REFERENCE TO RELATED APPLICATIONS

Pursuant to 35 USC § 119(e) and as set forth in the Application Data Sheet, this utility application claims the benefit of priority from U.S. Provisional Patent Application No. U.S. 61/044,273, which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Electrode arrays of varying scale, size and shape are used for electrical, chemical and biological sensing (and combinations of the three), for the electrophoretic manipulation of charged particles, for the dielectrophoretic manipulation of objects, cells and organisms, and for stimulating biological cells and tissues. Methods of manufacturing electrode arrays comprising metal or conductive alloy micro- and nano-wires, etched silicon, conductive polymers, carbon nanotubes (“CNT”), integrated circuit micro-electrode arrays, nano-electrode arrays, and others are known to those of skill in the art.

For example, U.S. Pat. No. 5,156,730 discloses a planar, conductive electrode array where each element of the array is individually wired and where time varying currents may be asserted onto each of these individually wired elements. U.S. Pat. No. 5,388,577 discloses a planar complementary-metal-oxide-semiconductor (“CMOS”) electrode array for sensing and stimulating cells, wherein the individual electrodes of the microchip must be connected directly and continuously to external voltage sources in order to control the potentials on these electrodes. U.S. Pat. No. 5,928,143 discloses a sharp, adjustable electrode array with preamplifiers whose inputs are connected to the electrodes and whose outputs are connected to external amplifiers whose gain is digitally programmable.

In addition, U.S. Pat. No. 5,965,452 discloses an integrated planar electrode array for carrying out and monitoring biological reactions, wherein each electrode has a driving amplifier element with an input storage capacitor for setting the output value of the driving element. The background section of that patent suggests that external erasable programmable read only memory (EEPROM) circuits may be used as an analog memory, but by comparison, no description is provided as to how such EEPROM cells might be connected to or integrated with the electrodes of the array, nor is there any disclosure as to how the EEPROM cells of such an array might be addressed or programmed in the context of such an array. In U.S. Pat. Nos. 6,258,606 and 6,682,936, which are related applications, the claims were amended to specify that the local memory element associated with the driving amplifier may be an EEPROM, but again by comparison there is no additional description made in support of either of these claims. This is also true for U.S. Pat. No. 7,101,717, another related patent, which does not claim local EEPROM memory, but does claim a separate memory associated with each electrode of the array for driving the electrode, the driven electrodes being driven at one of a plurality of stimulus levels by a source of electrical current or voltage external to the array.

With respect to the manipulation of charged particles, U.S. Pat. No. 5,632,957 discloses an integrated planar electrode array for computer controlled electrophoresis; individual electrodes are separately addressed by a software controlled data acquisition system for manipulating charged biological particles. U.S. Pat. Nos. 6,051,380, 6,068,818, 6,099,803, 6,540,961, 7,241,419, and 7,425,308 are related, and disclose similar systems.

Likewise, sharp electrode arrays (“sharps”) such as the Utah array described in C. T. Nordhausen, E. M. Maynard, and R. A. Normann, “Single unit recording capabilities of a 100-microelectrode array,” Brain Res., vol. 726, pp. 129-140, 1996, and Harrison, R. R., Watkins, P. T., Kier, R. J., Lovejoy, R. O., Black, D. J., Greger, B., Solzbacher, F., “A Low-Power Integrated Circuit for a Wireless 100-Electrode Neural Recording System,” IEEE Journal of Solid-State Circuits, vol. 42, January 2007, pp. 123-133, are often used for neural recording. U.S. Pat. No. 6,993,392 discloses a high-density multi-channel microwire electrode array for implementing a brain machine interface. U.S. Pat. No. 7,187,968 discloses an electrode array and associated circuitry for neural spike detection. U.S. Pat. No. 7,209,788 discloses a brain machine interface including an implantable electrode array.

In U.S. Pat. No. 7,019,305 an integrated electrode array for biosensing is disclosed wherein each electrode is coupled to the gate of a measuring transistor with associated calibration circuitry to at least partially compensate for offsets in threshold voltage of the measuring transistor. By comparison, the calibration circuitry does not include a memory. A publication by U. Frey, C. D. Sanchez-Bustamante, T. Ugniwenko, F. Heer, J. Sedivy, S. Hafizovic, B. Roscic, M. Fussenegger, A. Blau, U. Egert, and A. Hierlemann, “Cell Recordings with a CMOS High-density Microelectrode Array,” Proceedings of the 29^{th} Annual International Conference of the IEEE EMBS, Lyon, France, August 2007, pp. 167-170, discloses an integrated planar microelectrode array for recording action potentials from dissociated neurons cultured on the surface of the post-processed chip, having 11,016 metal electrodes and 126 readout channels with digitally programmable gain stages that are external to the array.

Nanoscale memory systems, such as those disclosed in U.S. Pat. Nos. 7,330,369 and 7,489,537 can be integrated with nano, micro or other sized electrodes. Although one of skill in the art would appreciate that electrode arrays fabricated using mature commercial integrated CMOS processes, or conventional microscale fabrication techniques like those used to create the Utah array, typically provide higher functional yield and better matched elements than first generation nano-electrode processes, one of skill in the art would also appreciate that nanoscale memory systems potentially offer an advantage of denser integrability, so long as it is possible to compensate for relatively low nano-device yield, and relatively high mismatch and process variability.

Conductive polymer electrodes are disclosed in, e.g., Urdaneta, M., Delille, R. and Smela, E., “Stretchable Electrodes with High Conductivity and Photo-Patternability,” Adv. Mater. 2007, vol. 19, pp. 2629-2633, and R. Delille, M. Urdaneta, K. Hsieh, and E. Smela, “Compliant electrodes based on platinum salt reduction in a urethane matrix,” Smart Mater. Struct., 2007, vol. 16 (2), pp. 272-279. Other conductive polymer electrode coatings are also reported—for example, in a publication by A. Widge, Malika Jeffries-EI, C. Lagenaur, V. Weedn and Yoky Matsuoka, “Conductive Polymer ‘Molecular Wires’ F or Neuro-Robotic Interfaces,” Proceedings of the 2004 IEEE International Conference on Robotics & Automation, New Orleans, La., 2004, pp. 5058-5063.

In addition, several research studies have shown that biological cells will grow directionally with applied electric fields—this phenomenon is known as galvanotropism and is described further in the documents comprising U.S. Provisional Patent Application No. U.S. 61/044,273, that has been incorporated herein by reference. It has been shown that the axons of growing nerve cells exhibit directional growth in electric fields, and thus it would be advantageous to have a means of controlling this growth for such applications as regeneration of damaged or diseased tissue, neural network formation, biosensing, and clinical research, among others.

Published U.S. Patent Application Ser. No. 20070092958, (“the '958 application”) discloses an integrated array of capacitors for stimulating neurons cultured on the surface, with a microcontroller that is electrically connected to the array of capacitors and configured to apply a time-varying electrical voltage onto one or more of these capacitors. The apparatus disclosed in the '958 application for implementing the time-varying electrical voltages, called a “lexel”, is described further in J. R. Keilman, G. A. Jullien, and K.V.I.S. Kalerf's paper, “A Programmable AC Electrokinetic Micro-particle Analysis System,” 2004 IEEE International Workshop on Biomedical Circuits and Systems. The lexel accomplishes dielectrophoresis by generating time-varying alternating current (“AC”) fields across elements of an electrode array using an external microcontroller. In addition to circuits for performing dielectrophoresis, the '958 application discloses the use of “growth permissive substances” to enable rapid and directed growth of axons/dendrites from cultured neurons on the surface of the capacitor arrays. The '958 application also identifies a number of problems associated with existing neural culture and growth.

There thus exists a need for compact, densely integrated (The phrase “densely integrated” is defined broadly in this application to mean densely spatially integrated, as for example an integrated circuit or other micro- or nano-array may be densely integrated. The phrase “densely integrated” is specifically not intended to be construed as limited to integrated circuits—it also describes other micro- or nano-electrode arrays, polymer electrode arrays, CNT arrays, etc.) programmable electrode arrays capable of generating arbitrary, dynamically reconfigurable electric fields between and around the electrodes of the array for manipulating the growth of biological cells and effectuating the movement of substances in contact with or proximity to the electrodes of the array at the micro- and nano-scale.

There exists a further need for compact, densely integrated programmable electrode arrays for sensing biological, chemical and other substances at the micro- and nano-scale, where the electrodes of the array have circuits, memories and/or other associated elements to compensate for electrode fabrication mismatch, process and other variations, as well as local inhomogeneities in the sensed environment.

There is also a general need to reduce the size, power consumption and design complexity of the aforementioned programmable electrode arrays to the extent possible in order to increase the density and resolution of the electrode arrays; to permit operation in environments where excessive heat dissipation or other EM radiation from, e.g., rapid circuit switching operations, is unacceptable, for example in neural implants; to extend battery-powered electrode sensor array lifetimes; to reduce overall costs; and for other reasons understood by those of skill in the art.

In addition, there is a particular need for programmable electrode arrays that can meet the aforementioned needs without consuming the excess power, time, and size overhead required by systems which need to repeatedly and rapidly update their driving voltage or calibration charge onto small integrated capacitors, and/or which require additional circuitry, including microcontrollers or other systems, external to the electrode array to maintain the driving voltage or calibration charge.

There is also a need for a method for manipulating and/or directing the movement and growth of biological cells, including the neurite outgrowth of nerve cells, without the requirement of neurotrophic factors, or external computers, microcontrollers or systems in order to sustain an electric field pattern on and around the electrodes of a programmable electrode array. A densely integrated programmable electrode array capable of directing the growth of neural tissue without the addition of neurotrophic factors could aid not only in clinical research studies, but also in the regeneration of damaged or diseased neural tissue.

The text by J. Baker, “CMOS Circuit Design, Layout and Simulation,” 2^{nd} Edition, Copyright 2005, Institute for Electrical and Electronics Engineers, Inc. (“IEEE”), and published by the IEEE and Wiley-Interscience (“the Baker text”) discloses fundamentals of integrated CMOS circuit design at the level of an undergraduate university course. In addition, the text “Floating Gate Devices: Operation and Compact Modeling” by P. Pavan, L. Larcher, and A. Marmiroli, Copyright 2004, Kluwer Academic Publishers, Inc., (“the FG text”) discloses information about the physics and general operation of floating gate devices. As one clarification, in this specification, we define “non-volatile analog memories” broadly to include floating gate devices, but also according to the plain and ordinary meaning of the words to include other analog memory devices that exhibit non-volatile storage, for example memristors, chalcogenides, organic and inorganic polymers, and CNTs.

The discussion of the background of the invention herein is included to explain the context of the invention. Although each of the patents and publications cited herein are hereby incorporated by reference, neither the discussion of the background nor the incorporation by reference is to be taken as an admission that any of the material referred to was published, known, or part of the common general knowledge as at the priority date of any of the claims.

### BRIEF SUMMARY OF THE INVENTION

The invention disclosed herein comprises compact, densely integrated programmable electrode arrays for sensing and manipulating biological cells and substances. By programming the non-volatile analog memory elements that are associated with one or more electrodes of the array, it is possible to generate arbitrary, dynamically reconfigurable electric field patterns on and around the electrodes at magnitudes which have been shown to induce neurite outgrowth and enhance cellular regeneration of damaged tissue. It is also possible to use the programmable electrode arrays to sense signals coupled to or in close proximity with the electrodes of the array, and to program arbitrary gain, calibration and offsets onto the individual electrodes of the array and/or their associated circuit elements.

### BRIEF DESCRIPTION OF THE SEVERAL VIEWS OF THE DRAWING

FIG. 1 is a top-down schematic view of a planar integrated programmable electrode array in accordance with one embodiment of the present invention.

FIG. 2 is a schematic diagram of an embodiment of an element of a programmable electrode array in accordance with the present invention.

FIG. 3 is a schematic diagram of a second embodiment of an element of a programmable electrode array in accordance with the present invention.

### DETAILED DESCRIPTION OF THE INVENTION

We disclose herein a programmable electrode array comprising a plurality of electrodes and one or more memory elements that are physically and/or electrically connected to one or more of the electrodes of the array. We further disclose methods of using the array to manipulate and sense cells and substances. In one embodiment of the array, a plurality of planar, passivated (covered with an insulating layer, such as silicon dioxide or silicon nitride) electrodes are formed in a commercially fabricated CMOS chip from one or more conductive regions which may be metal, polysilicon or other electrically conductive material; each electrode may also be physically and/or electrically connected to other circuits, components or physical layers of the chip.

In another embodiment of the array, a plurality of exposed electrodes are formed by selectively removing, or cutting, regions of the passivation layer of a commercially fabricated CMOS chip to expose one or more conductive regions of said chip which may themselves be metal, polysilicon or other electrically conductive material; each electrode may also be physically and/or electrically connected to other circuits, components or physical layers of the chip. With respect to this embodiment, if the electrodes were formed from the top metal layer on the CMOS chip, the exposed portions would form a substantially planar electrode. The electrodes of this embodiment may be exposed to the environment directly, or may be post processed with a conducting and/or corrosion resistant material, such as gold or platinum black. These materials can be deposited, or plated in a controlled fashion onto the exposed portion of one or more of the electrodes so that the electrode could be extended to the surface or above the surface of the chip, and also be made corrosion resistant and bio-compatible.

Using techniques known to those of skill in the art, it is possible to functionalize one or more of the exposed electrode surfaces with some other organic or inorganic material, such as linker molecules, DNA oligomers, antibodies, and many other substances known to those of skill in the art. Likewise, the insulation layer above one or more of the passivated electrodes may be functionalized for capacitively coupled sensing.

Other embodiments of the programmable electrode array include, but are not limited to, three-dimensional electrode arrays such as the Utah array comprising silicon spikes, metal or metal alloy micro- or nano-wire electrode arrays, substantially planar micro- or nano-electrode arrays, conductive polymer electrode arrays, and CNT electrode arrays which are associated with programmable memories according to the instant invention.

The programmable memory elements may be analog or digital, volatile or non-volatile, and may be reconfigurable, or reprogrammed only a limited number of times, or zero times. In one configuration, the memory elements are analog floating gates onto which arbitrary voltages (within a range set by the size and geometry of the memory element, the physical limits imposed by the process in which it was fabricated, and the operating voltages of any other electrical circuits which may be integrated with the memory element) which can be computed by one of skill in the art may be stored. Many other memory elements are known and may be incorporated into embodiments of this invention, including but not limited to: digital flip-flops and latches, integrated or discrete capacitors and MOScaps, magnetic, optical, organic, or biological storage media. More specific examples of technologies and devices that may comprise non-volatile analog memories known to those of skill in the art are memristors, chalcogenides, carbon nanotubes, and organic or inorganic polymers. As disclosed in several of the cited references, it is also possible to integrate planar CMOS electrode arrays with microwire or Utah array structures; similarly, it is possible to integrate programmable memory elements with micro- and nano-wire electrodes and polymer electrodes. Interfacing with carbon nanotube sensing elements is somewhat more difficult, but also understood by those of skill in the art.

In the case of analog floating gate memories, programming may be accomplished by some combination of electron injection, tunneling, and/or exposure to UV light. In the case of memristors, programming may be accomplished by passing electric currents through the memristor. Chalcogenide analog memories may be programmed using applied electric potentials, or voltages, across the memory element. CNT and polymer memories may be programmed in ways known to those of skill in the art.

In any case the individual electrodes may be physically and/or electrically connected to circuits such as amplifiers, and the memory elements may be used to program arbitrary offsets and gain of these amplifiers. Any combination of the elements of the above systems is also included within the scope of this invention, and in any of the disclosed inventions, circuits may be connected to the electrodes for sensing. Further, the electrodes and memory elements may be integrated with additional processing or sensing elements including, but not limited to CMOS or BiCMOS amplifiers, comparators or other circuits, discrete components such as capacitors, discrete sensors such as thermocouples or pH probes or potentiostats or other optical, electrical or chemical sensors, digital computers, microcontrollers, programmable integrated circuits (“PIC”), field-programmable-gate-arrays (“FPGA's”), organic circuits such as carbon nanotube networks, DNA or bacterial networks, or other circuits.

In one specific embodiment disclosed in the provisional and claimed below, the programmable electrode array is passivated and programming is used to store arbitrary voltages on the individual electrodes of the array to generate desired electric field patterns on and around the electrodes of the array. In one example of this embodiment, non-volatile analog memories are electrically connected to each electrode of the array; such memories may be floating gates or any of the other non-volatile analog memories disclosed.

The summary of attached research on galvanotropism suggests that it is possible to direct the movement, growth and regeneration of biological cells coupled onto or near the array surface in the presence of electric field patterns. Thus a method of this invention comprises directing the growth of cells, including the neurite outgrowth of nerve cells, by plating biological cells such as developing neurons (e.g. from mouse nasal explants, dissociated hippocampal neurons, etc. . . . ) onto the surface of a packaged planar passivated programmable electrode array and programming arbitrary electric field patterns onto the electrodes of the array to manipulate and direct the growth of such cells. Over time, it may be desired to reprogram or dynamically reconfigure the electric field pattern by adjusting the programmed voltage or potential (charge) on or more electrodes of the array. It should be noted that two- and three-dimensional versions of this array may also be used to generate arbitrary electric field patterns, for such applications as an implantable electrode array to facilitate the regeneration of damaged or diseased neural tissue.

In addition, the passivated (or functionalized) embodiments of the programmable electrode array may also be used to manipulate charged particles, chemicals or other substances on the surface of a planar version of the array. Arbitrary electric field patterns may be programmed onto the array by storing charge or voltage on the electrodes of the array, and electrophoretic forces will move charged particles along the electric field gradients. Non-planar, three-dimensional versions of the array may also be used to manipulate charged particles in substantially the same manner.

As another specific example, disclosed both in U.S. Provisional Patent Application No. 61/044,273 and a publication by A. Haas, entitled “Programmable High Density CMOS Microelectrode Array,” IEEE Sensors Conference, 2008, pp. 890-893, the individual electrodes of the array are electrically connected to integrated amplifiers, and the memory element may be used to program arbitrary offsets and gain of these amplifiers. As a result, it is possible to compensate for device mismatch, process variation and environmental inhomogeneity that can confound comparison of signals recorded from different sites on conventional electrode arrays. One advantage of this particular embodiment is that it maintains resolution rivaling the densest integrated electrode arrays—for the specific configuration disclosed in the provisional and the Haas publication, a 128×128 integrated programmable electrode array was fabricated in a commercial 0.5 μm CMOS process with electrodes spaced at 14 μm pitch, the same scale as biological cells. Characterization of this particular embodiment of the programmable array is disclosed in the provisional from this application claims priority, and also from the publication cited.

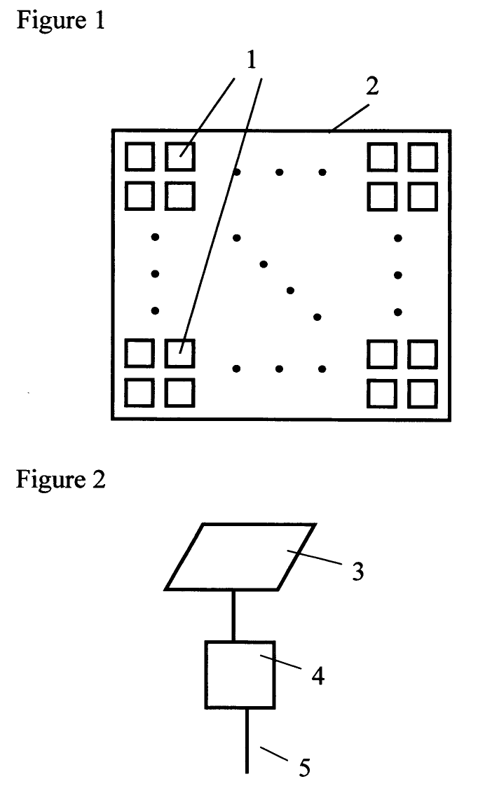

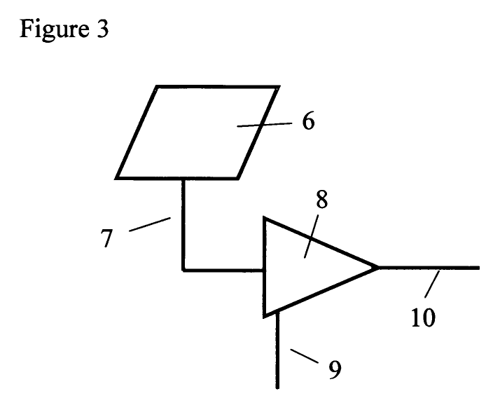

Although it is not believed that drawings are necessary for the understanding of the subject matter sought to be patented, for illustrative purposes we have included three figures related to specific embodiments of the disclosed invention. FIG. 1 is a top down view of a planar integrated programmable electrode array in accordance with an embodiment of the present invention, wherein the small labeled squares (1) represent a view of the exposed electrodes of this embodiment, whereas the large surrounding square (2) represents the passivated surface of electrode array of this embodiment. In FIG. 1, the black dots are ellipses intended to indicate that additional electrodes exist in the spaces traversed by the ellipses. FIG. 2 is a schematic diagram of an element of a programmable electrode array in accordance with one embodiment of the present invention, where (3) represents a generic electrode; (4) represents a generic memory element that is electrically connected to (3); and (5) represents the electrical connections to other circuitry for programming. FIG. 3 is a schematic diagram of an element of a programmable electrode array in accordance with another embodiment of the present invention, where (6) represents a generic electrode electrically connected by (7) to amplifier (8) which has programmable gain and offset, wherein programming is effectuated by means of signals on control bus (wires) (9), and (10) is the amplifier output.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. A programmable electrode array comprising a plurality of electrodes and at least one programmable memory element physically and/or electrically connected to at least one of the electrodes;

2. The programmable electrode array of claim 1, wherein there is at least one programmable memory element physically and/or electrically connected to each of the electrodes;

3. The programmable electrode array of claim 1, wherein the programmable memory elements comprise non-volatile analog memories;

4. The programmable electrode array of claim 3, wherein the non-volatile analog memories comprise floating gates;

5. The programmable electrode array of claim 3, wherein the non-volatile analog memories comprise memristors;

6. The programmable electrode array of claim 3, wherein the non-volatile analog memories comprise chalcogenides;

7. The programmable electrode array of claim 3, wherein the non-volatile analog memories comprise carbon nanotubes;

8. The programmable electrode array of claim 3, wherein the non-volatile analog memories comprise organic or inorganic polymers;

9. The programmable electrode array of claim 1, wherein the programmable charge storage element is a digital memory;

10. The programmable electrode array of claim 1, wherein the electrodes comprise metal or metal alloy micro- or nano-wires;

11. The programmable electrode array of claim 1, wherein the electrodes comprise substantially planar micro- or nano-electrodes;

12. The programmable electrode array of claim 1 fabricated in an integrated microchip, wherein the electrode array comprises a plurality of substantially planar metal regions supported on a surface of the microchip, insulating material covering the plurality of metal regions and the surface, and regions of metal electrically connected to said electrodes to form electrical connections from said electrodes to wire bonding or probe sites on an exposed surface of the microchip or to integrated circuitry within said microchip;

13. The programmable electrode array of claim 12, further comprising cuts in the insulating material, said cuts arranged to expose portions of the metal regions, whereby each exposed portion forms a substantially planar electrode, and comprising a conducting material deposited on each said electrode, whereby the resulting electrode is made to extend to the surface or above the surface of said microchip.

14. The programmable electrode array of claim 1, wherein the electrodes are sharps;

15. The programmable electrode array of claim 1, wherein the electrodes comprise silicon;

16. The programmable electrode arrays of claim 1, wherein the electrodes comprise conductive polymer;

17. The programmable electrode arrays of claim 1, wherein the electrodes comprise carbon nano-tubes;

18. The programmable electrode array of claim 1, wherein each electrode is electrically connected to a non-volatile analog memory, but is otherwise electrically insulated;

19. A programmable electrode array, comprising a plurality of electrodes and at least one programmable amplifier element having one or more inputs and one or more outputs, at least one of the inputs being physically and/or electrically connected to at least one of the electrodes, wherein the programmable amplifier element contains a memory;

20. A method of manipulating substances or cells comprising the steps of placing the substances or cells onto the surface of or in close proximity to an insulated programmable electrode array, and programming the array to generate a desired pattern of electrical fields across the electrodes of the array, and optionally periodically reprogramming the electrical fields across the electrodes of the array.
